(19) United States
(12) Patent Application Publication
(10) Pub. No.: US 2005/0183759 A1
(43) Pub. Date: Aug. 25, 2005

(54) Walker with harness for an elderly, handicapped or convalescent person

(76) Inventor: Mary Lynn Wolfe, League City, TX (US)

Correspondence Address: Thomas L. Warden;Winstead Sechrest & Minick P.C., P.O. Box 50784, Dallas, TX, 75201, US

(21) Appl. No.: 11/037,783

(22) Filed: Jan. 17, 2005

Related U.S. Application Data
(63) Continuation-in-part of application No. 10/653,547, filed on Sep. 2, 2003.

(51) Int. Cl. A61H 3/00

(52) U.S. Cl. 135/67

(57) ABSTRACT

A walker for elderly, handicapped or convalescing people which includes a frame with a top rail member positioned above a user's center of gravity and a harness located inside the frame and suspended from the top rail member to provide stability and resist tipping, enable hands free movement of the walker, and allow sitting in the walker. The walker further includes a plurality of substantially vertical frame members extending downward and outward to form a circumference around the user which is larger than a circumference formed by the top rail member. The harness includes a waist belt, a seat strap, and thigh straps such that the harness may be positioned and secured on the user. The walker may be provided with wheels for mobility or adjustable footpads for stable use with a treadmill. The walker may also be provided with lock-open hinges on selected frame members to permit collapsing the walker to a smaller size for easier transportation or storage.

This is as a continuation-in-part of U.S. patent application Ser. No. 10/653.547, entitled Walker With Harness for an Elderly, Handicapped or Convalescent Person, filed Sep. 2, 2003.

In accordance with 35 U.S.C. § 202(c)(6), the present invention was made with support by the United States government. The United States government has certain rights in the invention.

### BACKGROUND OF THE INVENTION

1. Field of the Invention

The present invention relates generally to mobile support devices and, more specifically, to an improved walker for an elderly, handicapped or convalescing person comprising a top rail member, a plurality of base members, a plurality of leg members communicating therebetween, and a plurality of ground engaging caster wheels connected to the underside of the base member. A section of the top rail member is pivotally hinged to allow for ease in entering and exiting the walker and is closed once the user is secured therein so that the person can grip the top rail member for support or move the improved walker along the ground with the hands free.

A harness made of nylon material attaches to the top rail member and has two substantially parallel belt members positioned one above the other with straps connecting the two. The upper belt is secured around the user's waist and the lower belt provides the means of attaching the harness to the top rail and has two sets of straps to secure the lower belt around the thighs of the user so that the user may sit thereon, while the larger base members having a greater circumference will maintain stability thereto and prevent the improved walker from falling over.

The present invention is an improved walker for elderly handicapped or convalescing people. The walker comprises a frame with a top rail member, base members, and a plurality of vertical leg members connecting the top rail member to the base members. The top rail member is waist high and forms a circumference around the user. It is composed of a top rail member that is waist high, and a plurality of base members, connected by a plurality of leg members. The base members have a larger circumference than the top rail to maintain stability and prevent the walker from falling over. Caster wheels are connected to the underside of the base members to enable the device to move along as a person walks. The person can grip the top rail member for support, or can walk in the device hands free. A section of the top rail member is pivotally hinged to allow for ease in entering and exiting the walker and is closed once the user is secured therein. A harness made of nylon material attaches to the top rail member and has two substantially parallel belt members positioned one above the other with straps connecting the two. The upper belt is secured around the user's waist and the lower belt provides the means of attaching the harness to the top rail and has two sets of straps to secure the lower belt around the thighs of the user so that the user may sit therein.

2. Description of the Prior Art

Numerous mobile support devices have been provided in prior art that are adapted to be utilized by elderly people with varying degrees of disability. While these units may be suitable for the particular purpose to which they address, they would not be as suitable for the purposes of the present invention as heretofore described.

### SUMMARY OF THE INVENTION

The present invention discloses an improved walker for an elderly, handicapped or convalescing person generally comprising a frame with a top rail member, base members, and a plurality of generally vertical leg members connecting the top rail member to the base members. The walker further includes a plurality of ground engaging caster wheels connected to the base members. Sections of the top rail member are pivotally hinged to a door to allow for ease in entering and exiting the walker so that the door is closed once the user is secured therein so that the person can grip the top rail member for support or move the improved walker along the ground with the hands free. A harness made of nylon material attaches to the top rail member and has two substantially parallel belt members positioned one above the other with straps connecting the two. The upper belt is secured around the user's waist and the lower belt provides the means of attaching the harness to the top rail and has two sets of straps to secure around the thighs of the user so that the user may sit thereon, while the base members with greater circumference will maintain stability thereto and prevent the improved walker from falling over.

A primary object of the present invention is to provide an improved walker that will overcome the shortcomings of the prior art devices.

Another object of the present invention is to provide an improved walker that will aid elderly, handicapped and convalescent persons in having healthier and more independent lives by enabling them to walk unattended without the risk of injury due to falling.

Yet another object of the present invention is to provide an improved walker that has a higher center of gravity so that it can be safely and conveniently used by a person who is prone to lose balance and fall since the present invention has the person secured to a harness suspended from the top rail of the walker that will support the user, if necessary, should the user happen to lose their balance.

Still another object of the present invention is to provide an improved walker wherein said harness is secured around the user's waist and thighs using straps with hook and loop fastening elements to provide reliable support that is fast and easy to connect.

Yet another object of the present invention is to provide an improved walker that is economical in cost to manufacture and operate.

Still another object of the present invention is to provide an improved walker that is adaptable for stable use in connection with treadmills of various sizes.

Yet another object of the present invention is to provide an improved walker that is collapsible to a small size for easier transportation or storage.

One more object of the present invention is to provide an improved walker that is simple and easy to use.

Additional objects of the present invention will appear as the description proceeds.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

### BRIEF DESCRIPTION OF THE DRAWINGS

In order that the invention may be more fully understood, it will now be described, by way of example, with reference to the accompanying drawings in which:

FIG. 1 is an illustrative view of the present invention in use.

FIG. 2 is a perspective view of the walker of the present invention.

FIG. 3 is a perspective view of the walker of the present invention.

FIG. 4 is a perspective view of the walker of the present invention with the gate open.

FIG. 5 is a detailed perspective view of the latch mechanism of the present invention.

FIG. 6 is a detailed perspective view of a caster wheel of the present invention.

FIG. 7 is a detailed perspective view of the hinge assembly of the present invention.

FIG. 8 is a rear view of the harness of the present invention.

FIG. 9 is a perspective view of the harness of the present invention.

FIG. 10 is a side view of an alternative embodiment of the present invention shown positioned for use with a treadmill.

FIG. 11 is a side detail view of an alternative embodiment of the present invention with wheels positioned on height-adjustable members.

FIG. 12 is a perspective view of an alternative, collapsible embodiment of the present invention.

### LIST OF REFERENCE NUMERALS

With regard to reference numerals used, the following numbering is used throughout the drawings.
10 present invention
12 user
13 frame
14 top rail
16 base member
17 support member
18 vertical post
19 legs
20 wheels
21 cross member
22 door
24 harness
26 rings
28 door latch
29 slam latch
30 lower latch catch
32 rubber jacket
34 hinge
36 door frame
40 caster rod
42 foot brake
44 brake on indicator
46 brake off indicator
52 welding
54 hinge pins
56 snap hooks
58 waist belt
60 waist belt buckle
62 first hook and loop element
64 second hook and loop element
66 grip handles
68 intermediate straps
70 support seat strap
72 thigh straps
74 first hook and loop element
76 second hook and loop element
78 ring
80 suspension straps
82 buckles
84 rear direction arrow
86 front direction arrow
88 upper horizontal door frame
90 lower horizontal door frame
92 caster wheel plate
100 treadmill
110 footpad
120 vertical adjustment member
130 bracket
140 detent
150 vertical hinge
160 front hinge
170 pivot sleeve
200 hinge
210 hinge plug
220 tubular frame member
230 hinge plate
240 locking sleeve
250 detent hole
260 detent pin

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments since practitioners skilled in the art will recognize numerous other embodiments as well. For a definition of the complete scope of the invention, the reader is directed to the appended claims.

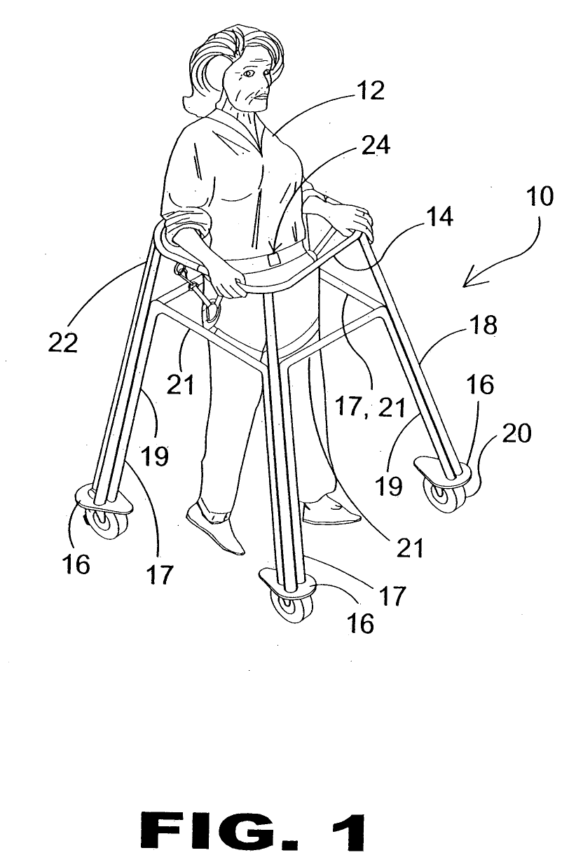

Turning to FIG. 1, shown therein is an illustrated view of the present invention 10 being an improved walker for elderly, handicapped or convalescent persons 12 that generally comprises a frame 13 with a top rail 14 attached to a base plate or member 16 at each corner at an angle by means of welded vertical multiple posts 18 which angle outwardly forming a structure that completely surrounds the user. Also shown is an additional support member 17 being downwardly U-shaped having legs 19 parallel and contiguous to vertical posts 18 and a cross-member 21 substantially perpendicular to legs 19. The plurality of base members 16 have a greater circumference than top rail 14 and each base member has a caster style wheel 20 on its underside providing easy mobility for the user 12. The rear entry door 22 latches in a closed position when the user 12 is within the structure. A harness 24 is attached to the top rail member 14 and passes around the waist and each thigh of the user 12 so that the user can sit thereon. Also note that the walker of the present invention 10 could be shaped to be substantially round rather than as shown in FIG. 1 wherein it is shown to be substantially rectangular.

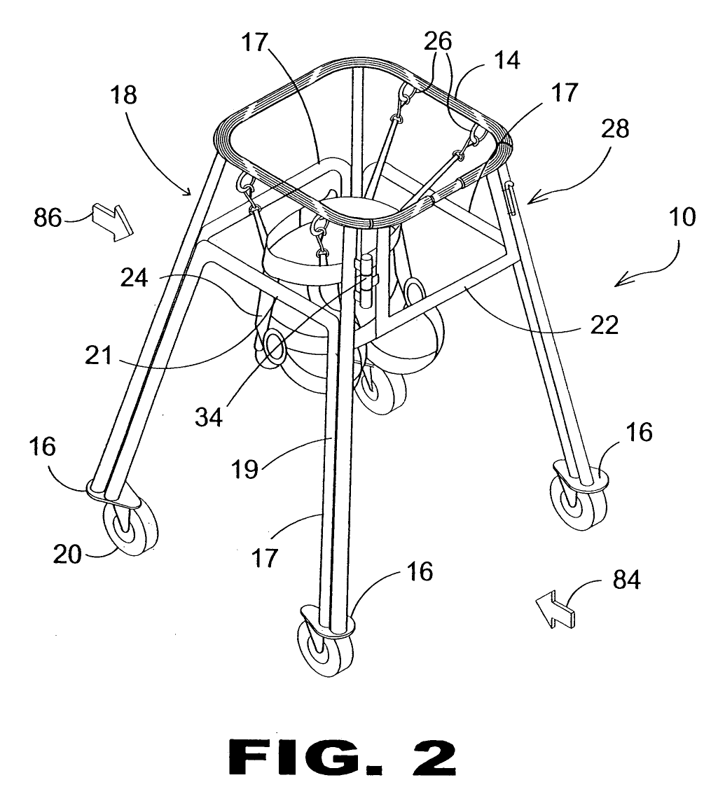

Turning to FIG. 2, shown therein is a perspective view of the present invention 10. Direction arrow 84 shows the rear of the present invention 10 and arrow 86 shows the front. Shown is a top rail 14 attached to multiple base plates or members 16 at an angle by means of welded vertical posts 18 forming a structure that completely surrounds the user. The four base members 16 have a greater circumference than the top rail 14 for added stability and a plurality of caster style wheels 20 providing easy mobility for the user. Additional support members 17 having legs 19 and cross-members 21 are also shown with the cross-members being disposed about one-third the distance between the top rail 14 and the base plates 16. The entry door 22 latches in a closed position when the user is within the structure. A harness 24 is attached to the top rail member 14 and passes around the waist and each thigh of the user so that the user can sit thereon. Shown is the vertical post 18 frame assembly of the present invention 10 with the entry door 22 in a closed and latched position. The door 22 can pivotally open at 34 when needed to enter or exit the structure. The door 22 is hingedly fastened at 34 to the main structural vertical post 18 allowing the door to pivotally open and close. A plurality of hook rings 26 are attached to the top rail 14 to which the harness 24 is attached. A door latch member 28 is also shown.

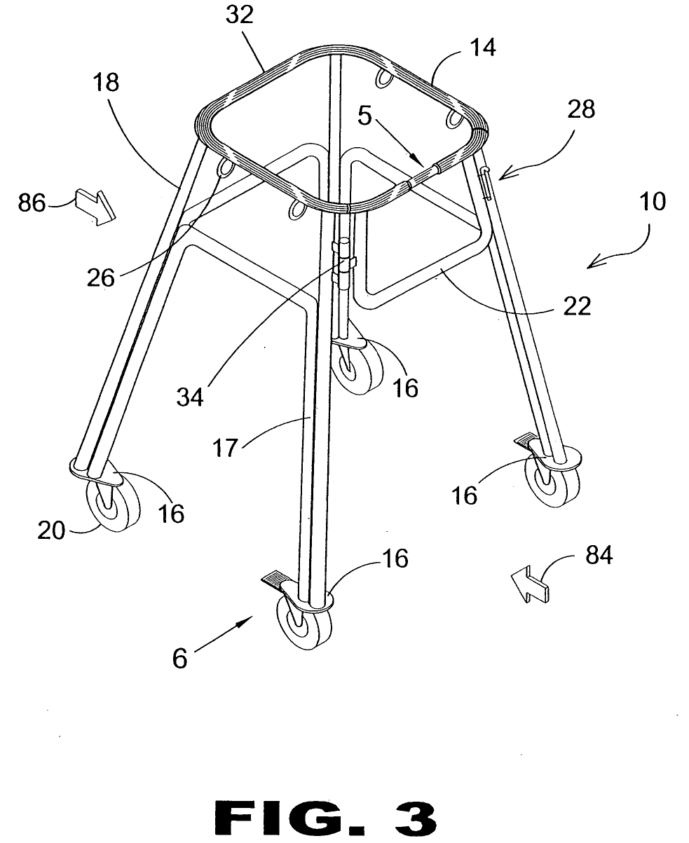

Turning to FIG. 3, shown therein is a perspective view of the present invention 10 with a rubber jacket 32 placed on the top rail 14 to cover the joints that separate the door 22 from the main frame structure 18 and to provide padding all the way around the top rail 14. The base plates 16, rings 26, door hinge 34, wheels 20, and latch member 28 are also shown. The front 86 and rear 84 of the present invention are also shown along with support member 17.

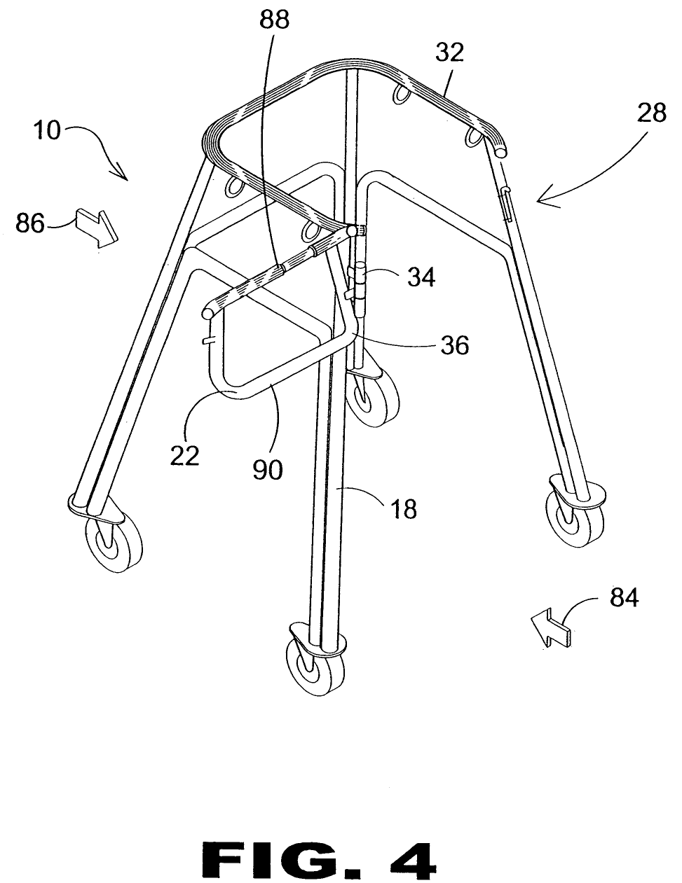

Turning to FIG. 4, shown therein is a perspective view of the present invention 10 with the door 22 open. The entry door 22 is shown in an open position to allow the user to enter or exit the structure. A rubber jacket 32 fits completely around the top rail and covers the joints that separate the door 22 from the main structure. The door 22 is hingedly fastened at 34 to the main structure post 18 to the door frame rail 36 allowing the door portion to pivotally open and close. The door has an upper and lower horizontal frame 88, 90. Latch 28 is also shown and the rear 84 and front 86 are also shown.

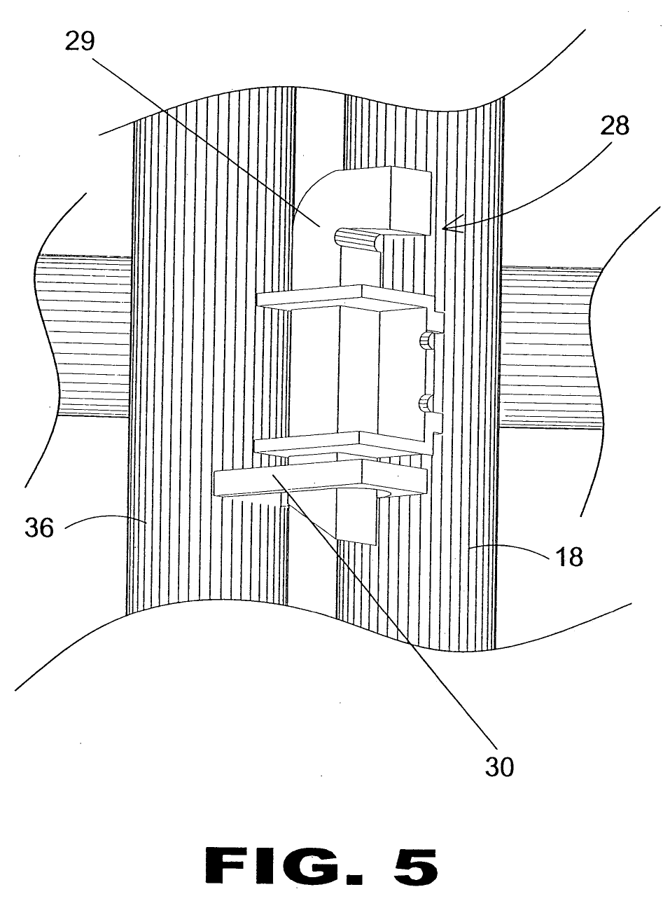

Turning to FIG. 5, shown therein is a perspective view of the latch assembly of the present invention showing the latch 28 having a slam latch bar 29 and a lower latch catch 30 in the closed or connected position. The slam latch 29 is disposed on post 18 and latch catch 30 is disposed on door frame 36 to permit the door to be secured to the post 18.

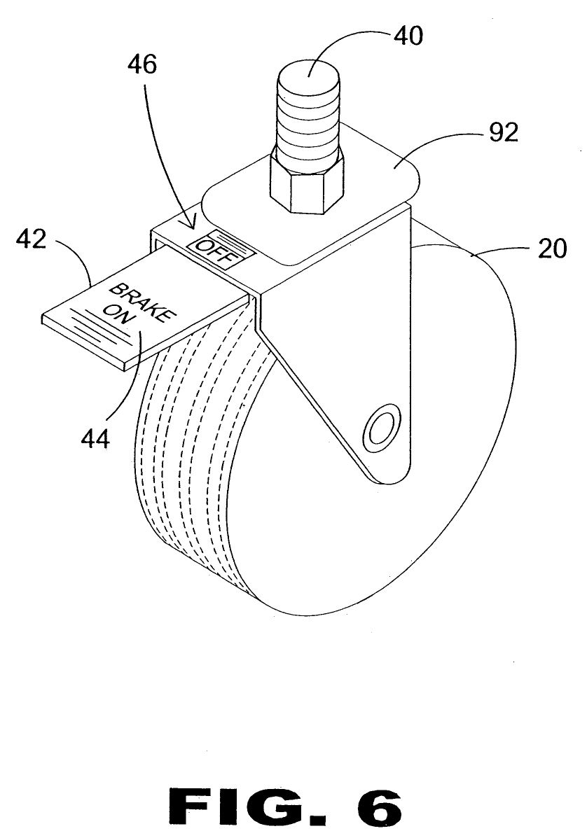

Turning to FIG. 6, shown therein is a detailed perspective view of a caster wheel 20 assembly of the present invention. Shown are a threaded caster rod 40, a caster wheel plate 92, and foot brake 42 which has an indicator to show that the brake is either on 44 or off 46. The caster rod 40 is designed to be attached to the bottom end of the base plate member and vertical posts.

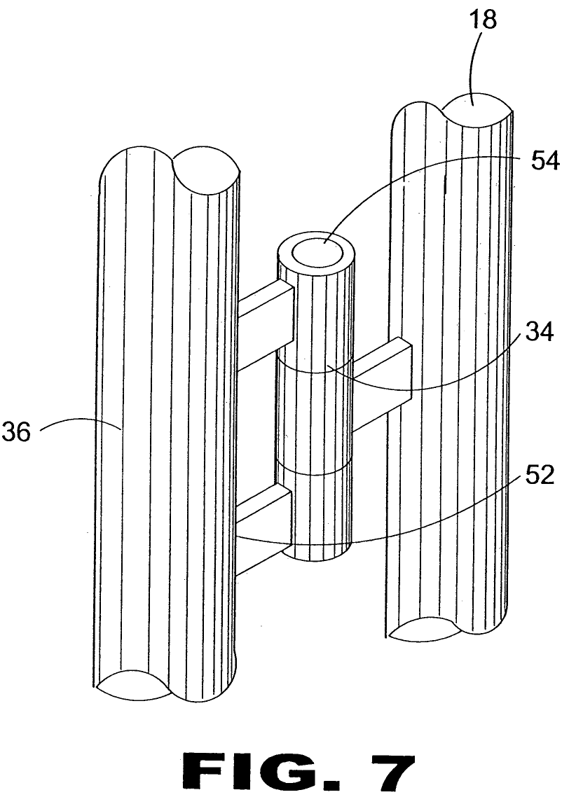

Turning to FIG. 7, shown therein is a detailed perspective view of the hinge assembly 34 with hinge pins 54 of the present invention that connect by welding 52 to the door frame 36 and to the main structure post 18 and allows for pivotal movement of the door from a closed position to an open position.

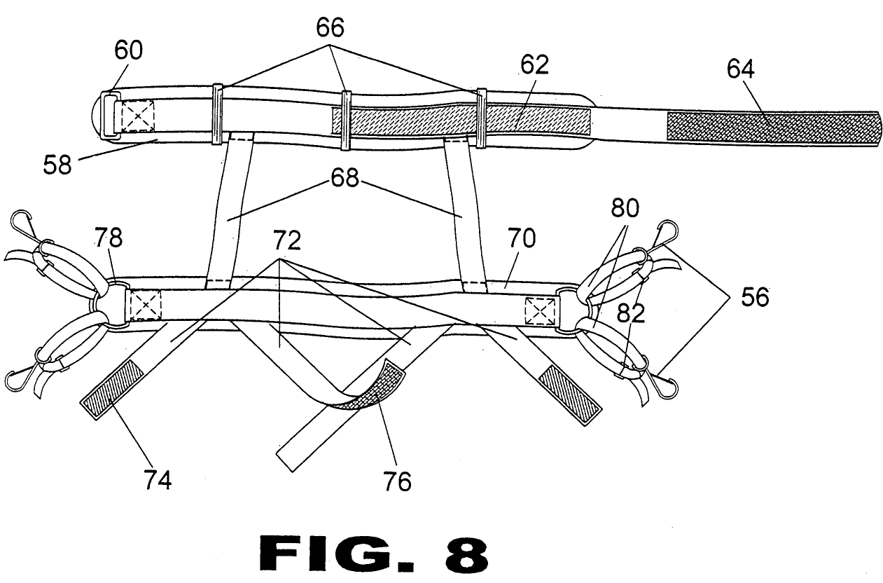

Turning to FIG. 8, shown therein is a rear view of the harness of the present invention which is worn by the user and attaches to the hook rings of the structure of the walker by means of multiple snap hooks 56 thereby securing the user within and providing a seat for rest. Shown is a waist belt member 58 with buckle 60 and a first 62 and second 64 hook and loop element having multiple grip handles 66 thereon. At least a pair of intermediate straps 68 connect the waist belt 58 to a support seat strap 70 which has a plurality of thigh straps 72 having a first 74 and second 76 hook and loop element thereon for connection about the thigh of the user. Also shown are suspension strap retaining rings 78 for connection of suspension straps 80 having buckles 82 and snap hooks 56 thereon.

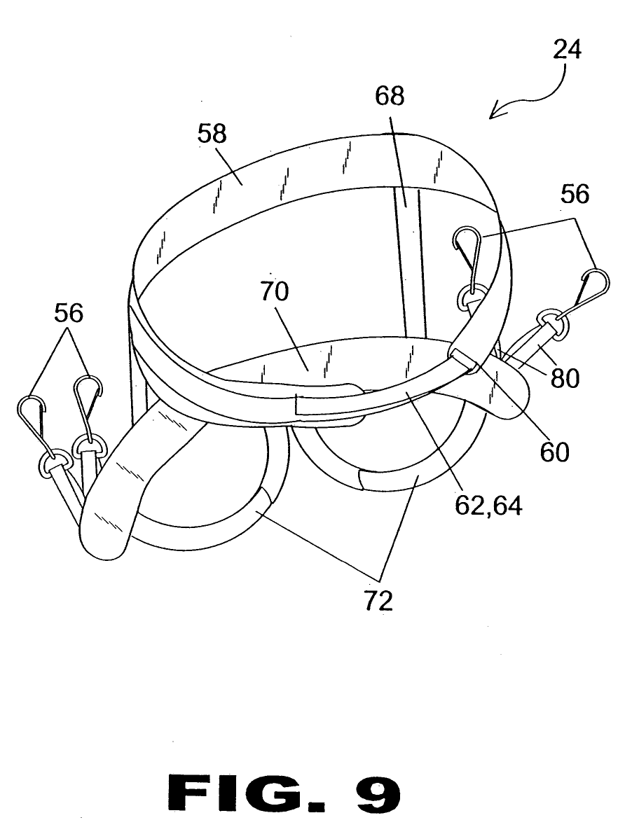

Turning to FIG. 9, shown therein is a perspective view of the harness 24 of the present invention as it would appear if all the connections were fastened to secure a person into the walker. Shown is a waist belt member 58 with buckle 60 and a first 62 and second 64 hook and loop element. At least a pair of intermediate straps 68 connects the waist belt 58 to a support seat strap 70 which has a plurality of thigh straps 72 for connection about the thigh of the user. Also shown are suspension straps 80 having snap hooks 56 thereon.

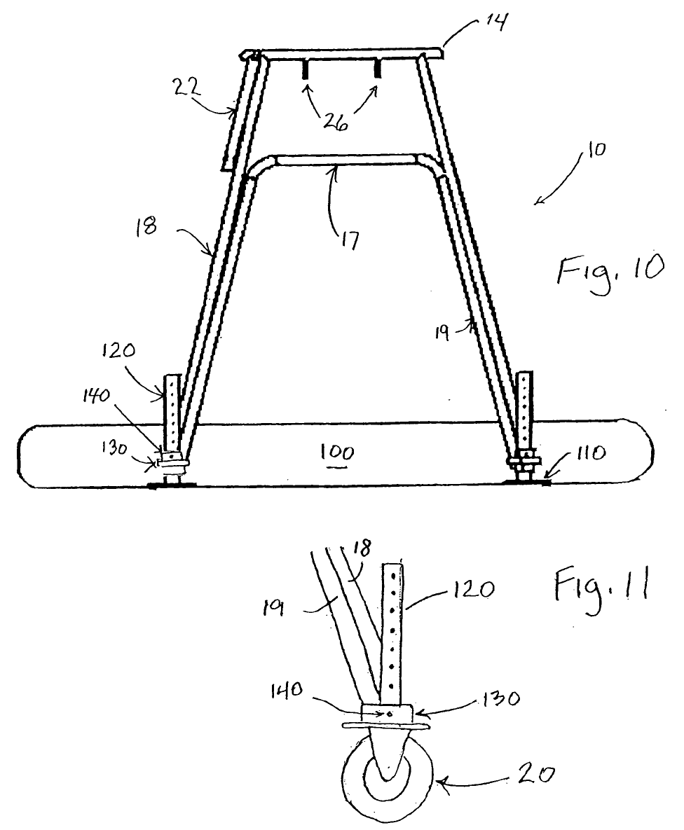

In another embodiment, the walker is provided with adjustable foot pads to provide steady support while a person uses the walker with a treadmill. In FIG. 10, the walker 10 is shown positioned above a treadmill 100. Note that the location of horizontal support members 17 provides clearance while using the walker 10 with treadmill 100. Walker 10 is shown equipped with adjustable foot pads 110 with a flat bottom surface such the walker 10 remains steady and stationary during use of the treadmill 100.

In FIG. 10, foot pads 110 are shown located at the bottom of each vertical post 18. Foot pads 110 optionally include vertical adjustment members 120, which slidably engage in bracket 130 located at the bottom of each vertical post 18. Bracket 130 further includes a bolt or detent mechanism 140 for engaging one of a plurality of holes in the vertical adjustment members 120 so that the overall height of the walker can be selectively adjusted and fixed as needed to use the walker with treadmills of various heights.

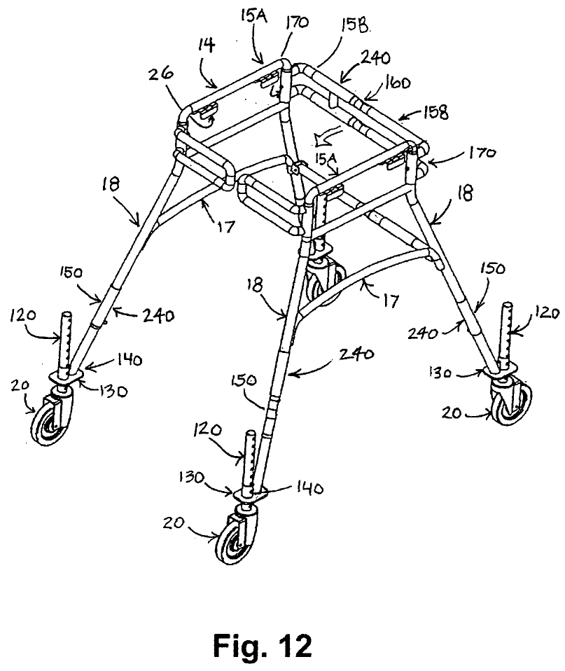

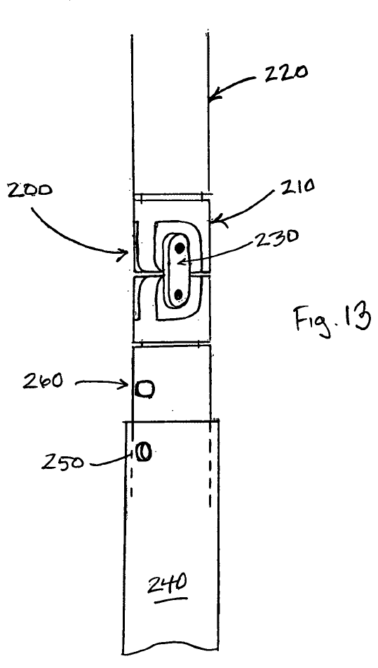

Alternatively, as shown in FIGS. 11 and 12, wheels 20 may be used in place of foot pads 110 to provide height adjustment during mobile uses of the walker. Here, wheels 20 are pivotably mounted at the bottom of vertical adjustment members 120 so that the overall height of the walker 10 may be easily adjusted up or down to provide optimum stability for users of different heights.

In yet another embodiment of the present invention, the frame members of the walker are split and fitted with hinges or pivots strategically located so that the walker may be folded to a more compact size for easier storage or transportation. As shown in FIG. 12, the walker frame is adapted to include vertical hinges 150 positioned at approximately the midpoint of each vertical post 18 so that vertical posts 18 may be folded in a stowed position to reduce the height of the walker.

Referring to FIG. 12, the top rail 14 is generally rectangular and includes side rails 15A and a front rail 15B. Front rail 15B includes a front hinge 160 positioned at approximately its midpoint. Each end of the front rail 15B includes additional pivot mechanisms at each distal end thereof, each being pivotably connected to vertical post 18. Preferably, these additional pivot mechanisms are formed by perpendicular pivot sleeves 170 of slightly larger inside diameter than the outside diameter of vertical post 18. Pivot sleeves 170 are welded or otherwise attached to front rail 15B and pivotably engage vertical post 18 near the top thereof. As shown in FIG. 12, front hinge 160 and pivot sleeves 170 are oriented such that front rail 15B may be collapsed inward in a generally horizontal plane indicated by the arrow. Thus, in a collapsed and stowed position, the width of walker 10 is substantially reduced and its height is reduced by approximately one-half.

As would be recognized by someone skilled in the field of the invention, with reference to this specification, vertical hinges 150 and front hinge 160 may be any number of hinge or pivoting connection designs that are capable of locking securely in the open position such that the hinge does not collapse while the walker is in use. In FIG. 13, there is shown a preferred embodiment of a lock-open hinge embodiment of vertical hinges 150 and front hinge 160 (FIG. 12). In FIG. 13, hinge 200 includes two hinge blocks or plugs 210 adapted to fit securely within each opposing end of a tubular frame member 220. Hinge 200 is formed by pivotably connecting each opposing hinge plug 210 with two opposing interior hinge plates 230. In this manner, the hinge 200 does not protrude beyond the outside diameter of tubular member 220.

FIG. 13 also depicts a preferred hinge-locking mechanism to prevent the hinges from collapsing during use of the walker. Locking sleeve 240 (also shown in FIG. 12) is formed from a tubular member of slightly larger inside diameter than the outside diameter of tubular member 220 such that, when positioned over tubular member 220, locking sleeve 240 slides along tubular member 220. When locking sleeve 240 is positioned over hinge 200 (e.g., vertical hinge 150 or front hinge 160 in FIG. 12), the hinge is locked in an open position to prevent the collapse of tubular member 220.

The preferred hinge-locking mechanism further includes a latch or detent pin to retain the locking sleeve 240 in an open or closed position. As shown in FIG. 13, locking sleeve 240 may include two detent holes 250 (only one of which is shown) positioned near opposite ends. The detent holes 250 are adapted to receive a spring-loaded detent pin 260 and thus prevent axial movement of the locking sleeve 240 along tubular member 220. In this manner, hinge 200 (e.g., vertical hinge 150 and front hinge 160 in FIG. 12) can be locked in an open position during use of the walker.

Although FIG. 12 depicts walker 10 with wheels 20 to provide mobility for elderly or handicapped persons, those skilled in the relevant field would also recognize that the collapsible walker of FIG. 12 could be readily adapted for use with a treadmill in the general manner shown in FIG. 10. In order to provide for such a collapsible walker adapted for stable use with a treadmill, wheels 20 shown in FIG. 12 may be removed and replaced with footpads 110 as shown in FIG. 10.

1. A walker comprising:
a frame further comprising
a top rail member positioned above the user's center of gravity;
a plurality of substantially vertical frame members extending downward from the top rail member at an outward angle to form a circumference at the lowermost ends thereof, the circumference being substantially larger than a circumference formed by the top rail member;
a plurality of support frame members connecting and supporting adjacent vertical frame members, the support frame members being positioned substantially above the lowermost ends of the vertical frame members;
a plurality of substantially vertical post members slidably connected near the bottom of each vertical frame member to provide height adjustment for the walker; and
a flexible harness suspended inside the frame for securing the user in the walker during use.

2. The walker of claim 1 further including an entry door hingedly connected to the frame.

3. The walker of claim 1 further including a plurality of wheels positioned at the bottom of each vertical post member, at least one of the wheels being pivotable for steering the walker.

4. The walker of claim 3 further including an entry door hingedly connected to the frame.

5. The walker of claim 4 wherein the harness further includes a seat strap portion.

6. The walker of claim 5 further including a foot brake on at least one of the wheels.

7. The walker of claim 1 further including a plurality of substantially flat pads positioned at the bottom of each vertical post member.

8. The walker of claim 7 further including an entry door hingedly connected to the frame.

9. The walker of claim 8 wherein the harness further includes a seat strap portion.

10. A walker comprising:
a top rail member positioned above the user's center of gravity, the top rail member comprising a front rail and two side rails;
a front hinge located approximately midpoint on the front rail;
a plurality of substantially vertical frame members extending downward from the top rail member at an outward angle to form a circumference at the lowermost ends thereof, the circumference being substantially larger than a circumference formed by the top rail member;
a plurality of support frame members connecting and supporting adjacent vertical frame members, the support frame members being positioned substantially above the lowermost ends of the vertical frame members; and
a plurality of vertical hinges located approximately midpoint of each vertical frame member;
wherein each distal end of the front rail is pivotably connected to the vertical frame members such that the walker collapses at the front hinge and folds at each vertical hinge for storage or transportation.

11. The walker of claim 10 further including a plurality of substantially vertical post members slidably connected near the bottom of each vertical frame member to provide height adjustment for the walker.

12. The walker of claim 10 further including a flexible harness suspended inside the frame for securing the user in the walker.

13. The walker of claim 11 further including a flexible harness suspended inside the frame for securing the user in the walker.

14. The walker of claim 13 wherein the harness further includes a seat strap portion.

15. The walker of claim 11 further including a plurality of substantially flat pads positioned at the bottom of each vertical post member.

16. The walker of claim 15 further including a flexible harness suspended inside the frame for securing the user in the walker.

17. The walker of claim 16 wherein the harness further includes a seat strap portion.

18. The walker of claim 10 wherein:
each vertical frame member has a top portion and a bottom portion, two opposing ends of which are connected by the vertical hinge; and
the vertical hinge further comprises a hinge plate pivotably connected to recessed portions formed in each opposing end of the vertical frame members;
such that each vertical frame member may be pivoted up to approximately 180 degrees in at least one direction to reduce the height of the walker for storage or transportation.

19. The walker of claim 18 further including a locking sleeve positioned on each vertical frame member adjacent to the vertical hinge, wherein the locking sleeve is slidably positionable to cover the vertical hinge so that each vertical frame member may be selectively locked in an open position.

20. The walker of claim 10 wherein:
the front rail has two portions with opposing ends adjacent to the front hinge, and two distal ends adjacent to the vertical frame members;
the two distal ends of the front rail are pivotably connected to the vertical frame members; and
the front hinge further comprises a hinge plate pivotably connected to recessed portions formed in each opposing end of the front rail;
such that the front rail may be pivoted inward in a generally horizontal plane to collapse the walker for storage or transportation.

21. The walker of claim 20 further including a locking sleeve positioned on the front rail adjacent to the front hinge, wherein the locking sleeve is slidably positionable to cover the front hinge so that the front rail may be selectively locked in an open position.

22. The walker of claim 18 wherein:
the front rail has two portions with opposing ends adjacent to the front hinge, and two distal ends adjacent to the vertical frame members;
the two distal ends of the front rail are pivotably connected to the vertical frame members; and
the front hinge further comprises a hinge plate pivotably connected to recessed portions formed in each opposing end of the front rail;
such that the walker may be collapsed in height by engaging the vertical hinges and collapsed in width by engaging the front hinge and pivoting the front rail inward in a generally horizontal plane, so that the walker may be more easily stored or transported.

23. The walker of claim 22 further including a locking sleeve positioned on each vertical frame member adjacent to the vertical hinge, wherein the locking sleeve is slidably positionable to cover the vertical hinge so that each vertical frame member may be selectively locked in an open position.

24. The walker of claim 23 further including a locking sleeve positioned on the front rail adjacent to the front hinge, wherein the locking sleeve is slidably positionable to cover the front hinge so that the front rail may be selectively locked in an open position.

25. The walker of claim 22 further including a plurality of substantially vertical post members slidably connected near the bottom of each vertical frame member to provide height adjustment for the walker.

26. The walker of claim 25 further including a plurality of wheels positioned at the bottom of each vertical post member, at least one of the wheels being pivotable for steering the walker.

27. The walker of claim 26 wherein the harness further includes a seat strap portion.

28. The walker of claim 25 further including a plurality of substantially flat pads positioned at the bottom of each vertical post member.

29. The walker of claim 28 wherein the harness further includes a seat strap portion.
